(19) United States
(12) Patent Application Publication
(10) Pub. No.: US 2020/0169705 A1
(43) Pub. Date: May 28, 2020

(54) VEHICLE SYSTEM

(71) Applicant: HONDA MOTOR CO., LTD., Minato-ku, Tokyo (JP)

(72) Inventors: Shun Iwasaki, Wako-shi (JP); Takafumi Hirose, Wako-shi (JP); Nobuyuki Watanabe, Wako-shi (JP); Jun Ito, Wako-shi (JP); Rie Fukushima, Wako-shi (JP); Hisakazu Yamane, Tokyo (JP); Masaaki Onoda, Tokyo (JP)

(21) Appl. No.: 16/622,336

(22) PCT Filed: Jun. 15, 2018
(86) PCT No.: PCT/JP2018/022929

§ 371 Date: Dec. 13, 2019

(30) Foreign Application Priority Data
Jun. 16, 2017 (JP) 2017-118689

(51) Int. Cl. H04N 9/31; B60R 16/037; B60R 11/02; G05D 1/00

(52) U.S. Cl. CPC H04N 9/31; B60R 16/037; B60R 2011/0003; G05D 1/0088; G05D 2201/0213; B60R 11/0229

(57) ABSTRACT

A vehicle includes an automated driving controller configured to execute automated driving of a vehicle and an environment provider configured to provide an interior of the vehicle with state information indicating a state of external equipment operable using an operation interface in the interior of the vehicle when the vehicle travels or stops, the external equipment being external equipment outside the vehicle.

### TECHNICAL FIELD

Priority is claimed on Japanese Patent Application No. 2017-118689, filed Jun. 16, 2017, the content of which is incorporated herein by reference.

### BACKGROUND ART

In recent years, research on automated driving of a vehicle has been conducted (see Patent Literature 1).

### CITATION LIST

### Patent Literature

[Patent Literature 1]
Japanese Unexamined Patent Application, First Publication No. 2017-61168

### SUMMARY OF INVENTION

### Technical Problem

An occupant does not need to perform a driving operation in the interior of an automated driving vehicle. Thus, the occupant can enjoy being together with his/her family, work, and use the time in the vehicle freely. However, the interior of the vehicle is often of inorganic materials with a uniform color tone and it may be difficult to enjoy a calm conversation or concentrate on work.

The present invention has been made in consideration of such circumstances and an objective of the present invention is to provide a vehicle system capable of providing a room environment according to a user's needs.

### Solution to Problem

(1): According to an aspect of the present invention, there is provided a vehicle system including: an automated driving controller configured to execute automated driving of a vehicle; and an environment provider configured to provide an interior of the vehicle with state information indicating a state of external equipment operable using an operation interface in the interior of the vehicle when the vehicle travels or stops, the external equipment being external equipment outside the vehicle.

(2): In the aspect (1), the environment provider provides the interior of the vehicle with at least one of information indicating a control state of the external equipment and an external state of the external equipment detected by a detector outside the external equipment.

(3): In the aspect (1), the environment provider provides the interior of the vehicle with the operation interface with respect to a remotely operable functional operation among all functional operations provided in the external equipment.

(4): In the aspect (3), the environment provider causes operation details received by the operation interface to be synchronized with a control state of the external equipment on the basis of the state information.

(5): In the aspect (1), the vehicle system further includes an identifier configured to identify an individual within the vehicle, wherein the environment provider identifies the external equipment capable of being used by the individual identified by the identifier and is connected to the identified external equipment.

(6): In the aspect (1), the environment provider includes a projector and causes the state information of the external equipment to be displayed within the vehicle.

(7) In the aspect (1), the vehicle system further includes a communicator configured to communicate with the external equipment, wherein the environment provider recognizes an operation on the operation interface performed by a person within the vehicle and controls the communicator so that the communicator transmits a control signal corresponding to the recognized operation to the external equipment.

(8): In the aspect (1), the environment provider changes operation details, which are received by the operation interface, on the basis of a traveling state of the vehicle.

(9): In the aspect (1), when the external equipment has been added, the environment provider adds the operation interface according to a function of the added external equipment.

(10): In the aspect (1), the environment provider determines the operation interface connected to the external equipment on the basis of at least one of a type of the external equipment, access right indicating whether or not use of the external equipment has been permitted, and a state of the external equipment.

(11): According to another aspect of the present invention, there is provided a vehicle system including: an automated driving controller configured to execute automated driving of a vehicle; an environment provider configured to provide an interior of the vehicle with state information indicating a state of external equipment controllable using an operation interface in the interior of the vehicle when the vehicle travels or stops, the external equipment being external equipment outside the vehicle; and a management device configured to manage communication between the automated driving controller and the environment provider.

### Advantageous Effects of Invention

According to the aspects (1) to (11), because a room environment specified by the user can be similarly reproduced within the vehicle, the time within the vehicle can be better spent.

According to the aspect of (5), because it is possible to reproduce a pseudo room environment capable of being used by a user after identifying an individual user, the user's private room environment can be securely and easily reproduced.

According to the aspects (1) to (11), because pseudo external equipment included in the room environment can also be reproduced within the vehicle and remote control of the external equipment is possible, it is possible to perform what a user could only do when he/she was in his/her room within the vehicle.

### BRIEF DESCRIPTION OF DRAWINGS

FIG. 1 is a configuration diagram of a vehicle system 1.

FIG. 2 is a configuration diagram of a vehicle 100.

FIG. 3 is an explanatory diagram showing a process of processing automated driving.

FIG. 4 is a functional configuration diagram of a room facility 200.

FIG. 5 is a functional configuration diagram of a management server 300.

FIG. 6 is a diagram showing an example of room information 322.

FIG. 7 is a sequence diagram showing an example of a process of the vehicle system 1.

FIG. 8 is a sequence diagram showing an example of a process of the vehicle system 1.

FIG. 9 is a diagram showing an example of a child's room reproduced within the vehicle 100.

FIG. 10 is a diagram showing an example of a cafe-like room reproduced within the vehicle 100.

FIG. 11 is a diagram showing an example of a work room reproduced within the vehicle 100.

FIG. 12 is a diagram showing an example of a living room of a user's home reproduced within the vehicle 100.

FIG. 13 is a view of a state in which a combination room region appears by combining the vehicle 100 and a room 600 viewed from above.

FIG. 14 is a view of a state in which the vehicle 100 and the room 600 are separated viewed from above.

FIG. 15 is a diagram showing an example of details of interface information 323.

### DESCRIPTION OF EMBODIMENTS

Embodiments of a vehicle and a vehicle system of the present invention will be described below with reference to the drawings. The vehicle is, for example, an automated driving vehicle that does not basically require a driving operation. In the vehicle system, an automated driving vehicle is used to provide a room environment according to a user's needs.

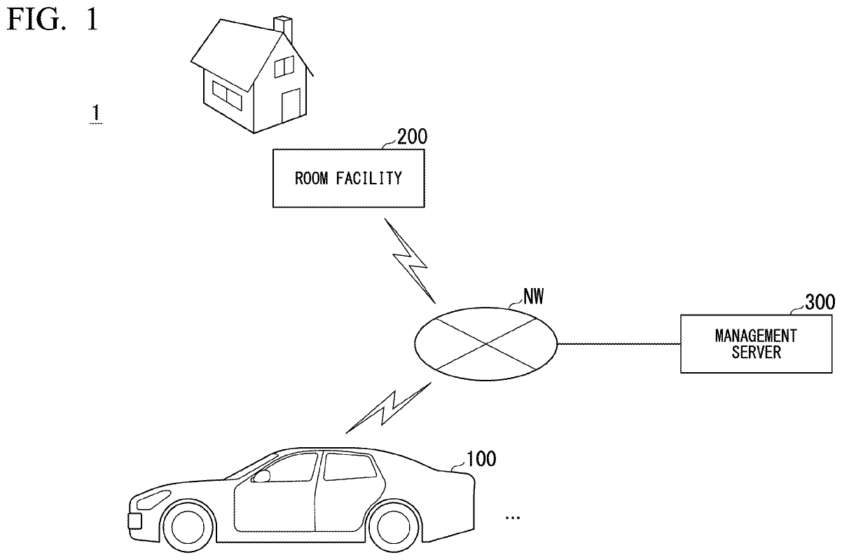

FIG. 1 is a configuration diagram of a vehicle system 1. The vehicle system 1 includes one or more vehicles 100, one or more room facilities 200 installed in a room capable of being used by a user, and a management server 300. These components can communicate with each other via a network NW. The network NW includes the Internet, a wide area network (WAN), a local area network (LAN), a public circuit, a provider device, a dedicated circuit, a wireless base station, and the like.

A room that can be used by a user is a room where the use of the user has been previously permitted by an owner of the room, a manager, or the like and is, for example, the user's home or workplace, a hotel or an inn where the user stays, or the like. The room that can be used by the user is an example of a space outside the vehicle 100 and equipment present in the room facility 200 is an example of an external device present in a space outside the vehicle 100. As will be described below, the external equipment includes an object that is remotely operated by the user from the interior of the vehicle on the basis of operation information acquired through an operation interface prepared within the vehicle. Hereinafter, although the external equipment will be described as a configuration included in the room facility 200, the present invention is not limited thereto. For example, the external equipment is equipment other than the equipment mounted on the vehicle 100 and may include, for example, equipment mounted on another vehicle.

### [Vehicle]

The vehicle 100 creates a room request on the basis of an operation of a user U and transmits the room request to the management server 300 via the network NW. The room request is a request for an instruction for reproducing a pseudo room environment in the interior of the vehicle 100, and includes usage conditions such as a type of room and an attribute of the user U, identification information of the vehicle 100, and the like. The room request does not need to be transmitted every time the user U gets into the vehicle 100. Once the room request is transmitted, provision of the room environment may be continued until the room request is canceled.

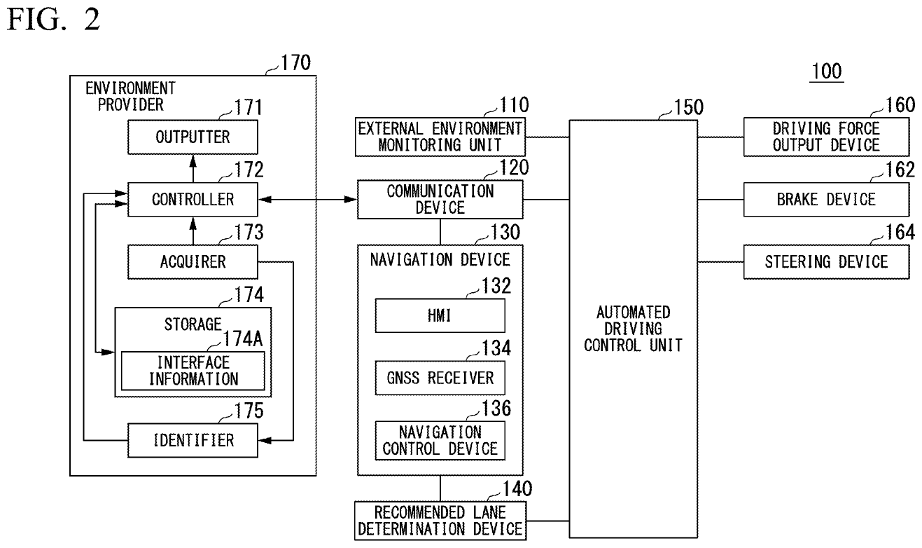

The vehicle 100 is, for example, a vehicle having four or more wheels into which a plurality of users U can get. FIG. 2 is a configuration diagram of the vehicle 100. The vehicle 100 includes, for example, an external environment monitoring unit 110, a communication device 120, a navigation device 130, a recommended lane determination device 140, an automated driving control unit 150, a driving force output device 160, a brake device 162, a steering device 164, and an environment provider 170.

The external environment monitoring unit 110 includes, for example, a camera, radar, a light detection and ranging (LIDAR) finder, a physical object recognition device for performing a sensor fusion process based on outputs thereof, and the like. The external environment monitoring unit 110 estimates types of physical objects (particularly, vehicles, pedestrians, and bicycles) present around the vehicle 100 and outputs the estimated types of physical objects to the automated driving control unit 150 together with position and speed information thereabout.

The communication device 120 is, for example, a wireless communication module for connecting to the network NW or directly communicating with a terminal device of another vehicle or a pedestrian and the like. The communication device 120 performs wireless communication on the basis of Wi-Fi, dedicated short range communications (DSRC), Bluetooth (registered trademark), and other communication standards. A plurality of communication devices 120 may be prepared depending on a purpose.

The navigation device 130 includes, for example, a human machine interface (HMI) 132, a global navigation satellite system (GNSS) receiver 134, and a navigation control device 136. The HMI 132 includes, for example, a touch panel display device, a speaker, a microphone, and the like. The GNSS receiver 134 measures a position of its own device (a position of the vehicle 100) on the basis of radio waves received from a GNSS satellite (for example, a GPS satellite). The navigation control device 136 includes, for example, a central processing unit (CPU) and various types of storage devices and controls the entire navigation device 130. Map information (a navigation map) is stored in the storage device. The navigation map is a map that expresses roads by nodes and links. The navigation control device 136 determines a route from the position of the vehicle 100 measured by the GNSS receiver 134 to a destination specified using the HMI 132 with reference to the navigation map. Also, the navigation control device 136 may transmit the position and destination of the vehicle 100 to a navigation server (not shown) using the communication device 120 and acquire a route returned from the navigation server. Also, the route may include information about a stop point and a target arrival time for allowing the user to get into or out of the vehicle. The navigation control device 136 outputs information about the route determined by any one of the above methods to the recommended lane determiner 140.

The recommended lane determiner 140 includes, for example, a micro processing unit (MPU) and various types of storage devices. The storage device stores high-accuracy map information that is more detailed than the navigation map. The high-accuracy map information includes, for example, information such as a road width and a gradient for each lane, curvature, and a signal position. The recommended lane determiner 140 determines a preferable recommended lane for traveling along the route input from the navigation device 130 and outputs the recommended lane to the automated driving control unit 150.

The automated driving control unit 150 includes one or more processors such as the CPU and the MPU and various types of storage devices. The automated driving control unit 150 causes the vehicle 100 to travel in the recommended lane determined by the recommended lane determiner 140 in principle and causes the vehicle 100 to automatically travel in order to avoid contact with an object whose position and speed are input from the external environment monitoring unit 110. For example, the automated driving control unit 150 sequentially executes various types of events. The events include, for example, a constant-speed traveling event for traveling in the same travel lane at a constant speed, a following traveling event for following a preceding traveling vehicle, a lane change event, an interchange event, a junction event, an emergency stop event, a tollgate event for passing through a tollgate, a handover event for ending automated driving and performing switching to manual driving, and the like. Also, during execution of these events, actions for avoidance may be planned on the basis of a surrounding situation of the vehicle 100 (presence of nearby vehicles and pedestrians, lane narrowing due to road construction, or the like).

The automated driving control unit 150 generates a target trajectory on which the vehicle 100 will travel in the future. For example, the target trajectory includes a speed element. For example, the target trajectory is represented by sequentially arranging points (trajectory points) at which the host vehicle M is required to arrive. The trajectory point is a point where the host vehicle M is required to reach for each predetermined traveling distance. In addition, a target speed and target acceleration for each predetermined sampling time (for example, about several tenths of a second [sec]) are generated as parts of the target trajectory. The trajectory point may be a position at which the host vehicle M is required to arrive at the sampling time for each predetermined sampling time. In this case, information about the target speed or the target acceleration is represented by an interval between the trajectory points.

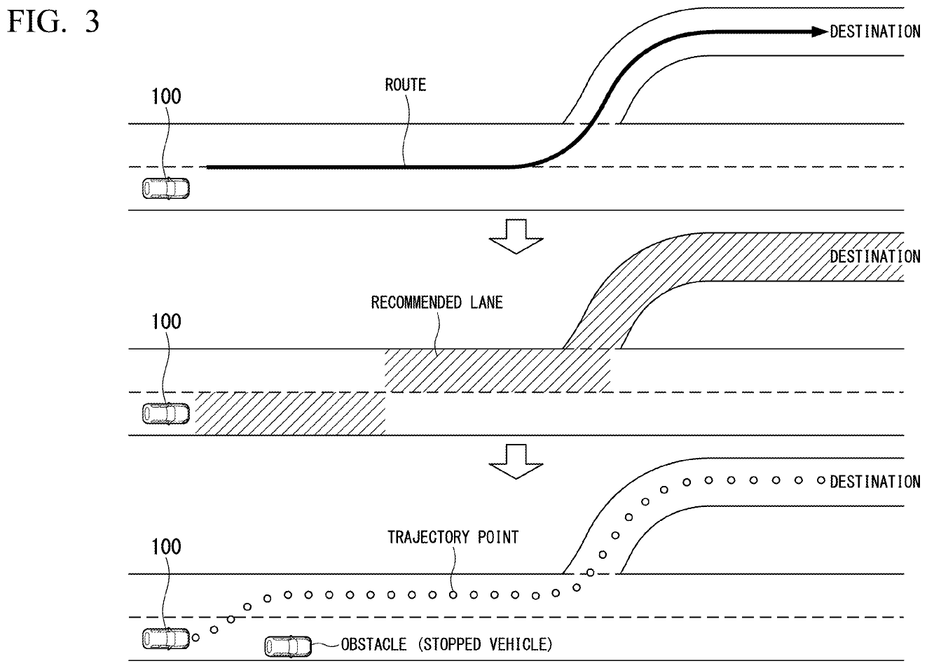

FIG. 3 is an explanatory diagram showing a process of processing automated driving. First, as shown in the top of FIG. 3, a route is determined by the navigation device 130. This route is, for example, a rough route with no lane distinction. Next, as shown in the middle of FIG. 3, the recommended lane determiner 140 determines a recommended lane in which the vehicle can easily travel along the route. Then, as shown in the bottom of FIG. 3, the automated driving control unit 150 generates a trajectory point for traveling along the recommended lane as much as possible while avoiding obstacles, etc. and controls some or all of the driving force output device 160, the brake device 162, and the steering device 164 so that the vehicle travels along trajectory points (and an accompanying speed profile). Also, such division of roles is merely an example, and, for example, the automated driving control unit 150 may perform a process in an integrated manner.

The driving force output device 160 outputs a travel driving force (torque) to drive wheels for the vehicle to travel. For example, the driving force output device 160 includes a combination of an internal combustion engine, an electric motor, a transmission, and the like, and a power ECU configured to control them. The power ECU controls the above-described components in accordance with information input from the automated driving control unit 150 or information input from a driving operation element (not shown).

For example, the brake device 162 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the automated driving control unit 150 or the information input from the driving operation element so that brake torque according to a braking operation is output to each wheel. The brake device 162 may include a mechanism configured to transfer the hydraulic pressure generated by an operation of the brake pedal included in the driving operation element to the cylinder via a master cylinder as a backup. Also, the brake device 162 is not limited to the above-described configuration and may be an electronically controlled hydraulic brake device configured to control the actuator in accordance with information input from the automated driving control unit 150 and transfer the hydraulic pressure of the master cylinder to the cylinder.

For example, the steering device 164 includes a steering ECU and an electric motor. For example, the electric motor changes a direction of steerable wheels by applying a force to a rack and pinion mechanism. The steering ECU drives the electric motor in accordance with the information input from the automated driving control unit 150 or the information input from the driving operation element to change the direction of the steerable wheels.

The environment provider 170 includes an outputter 171, a controller 172, an acquirer 173, a storage 174, an identifier 175, and an authenticator 176.

For example, the environment provider 170 reproduces the environment of the room including the room facility 200 in the vehicle 100 by providing the interior of the vehicle with state information indicating the state of the external equipment included in the room facility 200. The state information of the external equipment includes, for example, information indicating the control state of the external equipment, information indicating the external state of the external equipment detected by the detector outside the external equipment, and the like.

The control state of the external equipment includes, for example, a state in which a television is turned on, a rice cooking state of a rice cooker, and the like. Also, the control state of the external equipment includes a functional operation possessed by the external equipment in advance (or an operation associated with the functional operation) and a functional operation set in the external equipment. The functional operation of the external equipment includes, for example, an operation of adjusting the volume of the television, a level value (a setting value) of the set volume, and the like. The functional operation set in the external equipment also includes a functional operation that can be remotely operated from outside, a functional operation that cannot be remotely operated from outside, and the like. The control state of the external equipment also includes an operation state of the external equipment and the like.

The detector is a component that is not included in the external equipment. The detector is not limited to a camera. For example, it is only necessary for the detector to detect an external state of the external equipment. The detector may include a thermometer, an illuminometer, a speaker, and the like. The external state of the external equipment includes a state of the external equipment observed from outside, a state of a surrounding environment where the external equipment is placed, and the like.

Providing state information to the interior of the vehicle includes displaying an image or text indicating the control state of the external equipment to the interior of the vehicle, displaying an image or text of a functional operation set in the external equipment to the interior of the vehicle, and the like. Also, providing the state information to the interior of the vehicle may include displaying an image or text of an operation interface within the vehicle with respect to a functional operation on the external equipment.

The outputter 171 reproduces a predetermined room environment by causing the state information to be displayed in the interior of the vehicle 100 on the basis of information for displaying the state information within the vehicle (hereinafter referred to as reproduction data). For example, the reproduction data is generated by the controller 172 on the basis of information received from the room facility 200 or the management server 300. Also, the reproduction data may be generated by the room facility 200 or the management server 300, or may be partially generated by the room facility 200 or the management server 300 and finally generated by the controller 172 on the basis of a part thereof.

For example, the outputter 171 causes a predetermined image to appear within the vehicle on the basis of the reproduction data. A means for causing the predetermined image to appear may be a method of projecting an image onto a wall within the vehicle using a projector, or a method of displaying an image on a display installed within the vehicle. Also, the predetermined image includes not only an image related to the external equipment but also various images for reproducing a specified space, and also includes an image related to a structure such as wallpaper or a floor of the specified space, an image related to a structure such as furniture or home appliances present in the specified space, and the like.

The outputter 171 includes, for example, one or more of a projector, a display, a speaker, and the like. The reproduction data differs according to the reproduction means in the vehicle 100. For example, data to be projected onto an interior surface of the vehicle 100 if the reproduction means in the vehicle 100 is a projector, data to be displayed on a display if the reproduction means in the vehicle 100 is a display, and the like are included. Also, the outputter 171 may reproduce the room environment using projection mapping technology.

Also, the outputter 171 notifies the interior of the vehicle of a situation of the external equipment present in the room facility 200. For example, an image according to a situation of the device present in the room facility is output, or words or illustrations indicating a situation of the equipment present in the room are output as an image or a sound, on the basis of information received from the room facility 200. Details will be described below.

The acquirer 173 includes, for example, an interface device that receives an operation of a user and outputs details of the received operation to the controller 172. The acquirer 173 includes, for example, a keyboard, a mouse, a touch panel, and the like. Also, the acquirer 173 includes a camera and a sensor, and the controller 172 may analyze characteristics of the user U and details of an operation of the user U on the basis of an image captured by the camera, a detection result of the sensor, and the like. For example, when the controller 172 has detected the movement of the user U who touches an operation button of the pseudo external equipment reproduced in the room environment within the vehicle, the controller 172 detects details of the operation on the external equipment. That is, the controller 172 and the acquirer 173 may function as operation interfaces that receive an instruction for remotely operating the external equipment reproduced within the vehicle as a pseudo image.

Also, the acquirer 173 acquires a traveling state of the vehicle 100. The traveling state of the vehicle 100 is indicated by, for example, an event executed by the automated driving control unit 150, the speed of the host vehicle, the position of the vehicle 100 measured by the GNSS receiver 134, a shape of a road on which the vehicle 100 is traveling (a road over a mountain pass, a straight road, or the like), or the like. For example, the acquirer 173 acquires information indicating a type of event executed by the automated driving control unit 150 using the communication device 120.

The storage 174 is implemented by a hard disk drive (HDD), a flash memory, a random access memory (RAM), a read only memory (ROM), or the like.

The controller 172, the identifier 175, and the authenticator 176 are implemented, for example, by a processor such as a CPU executing a program (software) stored in the storage 174. Also, some or all of these functional parts may be implemented, for example, by hardware such as large scale integration (LSI), an application specific integrated circuit (ASIC), or a field-programmable gate array (FPGA) or may be implemented by cooperation between software and hardware. The program may be pre-stored in a storage device such as an HDD or a flash memory or pre-stored in a removable storage medium such as a DVD or a CD-ROM. The program may be installed in a storage device when the storage medium is mounted in a drive device.

The controller 172 creates a room request on the basis of information input from the user U using the acquirer 173, an identification result of the identifier 175, an authentication result of the authenticator 176, and the like, and uses the created room request to the management server 300 using the communication device 120. For example, the controller 172 includes usage conditions such as a name and an attribute of the user and a type of room in the room request.

Also, the controller 172 generates reproduction data on the basis of information received from the room facility 200 or the management server 300. Also, the controller 172 may acquire the reproduction data from the room facility 200 or the management server 300. The controller 172 outputs the reproduction data to the outputter 171.

Also, the controller 172 provides an operation interface for receiving an operation on the external equipment within the vehicle. For example, the controller 172 generates information in which identification information for identifying each part included in the acquirer 173 (hereinafter referred to as an operation interface ID) is associated with identification information for identifying an operation on the external equipment (hereinafter referred to as an operation ID) and stores the generated information as a part of the interface information 174A in the storage 174. Also, the interface information 174A may include information for identifying a combination of the operation interface ID and the operation ID (hereinafter referred to as an interface ID). In the interface information 174A, for example, a button A displayed on the touch panel is registered as an operation interface for turning on a power supply of the television. This interface information 174A may be the same information as all or part of the interface information 323 to be described below.

Also, the controller 172 provides an operation interface for a functional operation that can be remotely operated from the interior of the vehicle among all functional operations provided in the external equipment within the vehicle. For example, the controller 172 determines operation details received by the operation interface in accordance with whether or not a remote operation from the vehicle is possible. When the functional operation that can be remotely operated from the vehicle among all the functional operations provided in the external equipment is limited, the controller 172 provides the operation interface of the functional operation that can be remotely operated from the vehicle within the vehicle. Specifically, the controller 172 registers the interface ID in the interface information 174A in association with the operation ID of the functional operation that can be remotely operated from the vehicle and does not register an operation ID of the functional operation that cannot be remotely operated from the vehicle in the interface information 174A. Also, the controller 172 may set a flag indicating that the operation ID of the functional operation that cannot be remotely operated from the vehicle is invalid.

Also, an example in which a remote operation from the vehicle is limited will be described. For example, although an operation of the television itself such as an operation of turning on the television can be remotely operated from the vehicle when the external equipment is a television, recording equipment connected to the television can be remotely operated from the vehicle. Also, an operation on the recording equipment is an operation of the recording equipment and an operation interface may be provided by the controller 172.

Also, the controller 172 may determine operation details to be received by the operation interface in accordance with, for example, whether or not the occupant is an individual authenticated by the authenticator 176. When a functional operation in which an operation of the occupant is permitted among all functional operations provided in the external equipment is limited, the controller 172 provides the operation interface of the functional operation in which the operation of the occupant is permitted within the vehicle. Specifically, the controller 172 registers the interface ID in the interface information 174A in association with an operation ID of a functional operation in which an operation of the occupant is permitted and does not register an operation ID of a functional operation in which an operation of the occupant is not permitted in the interface information 174A. Also, the controller 172 may set a flag indicating that the operation ID of the functional operation in which an operation of the occupant is not permitted is invalid.

Also, the controller 172 causes operation details received by the operation interface to be synchronized with a control state of the external equipment on the basis of information received from the room facility 200 or the management server 300 using the communication device 120. For example, the controller 172 determines operation details that are received by the operation interface on the basis of latest information received from the room facility 200 or the management server 300.

Also, the controller 172 may include a clock function part and cause synchronization with a clock time measured by the clock function part included in the external equipment to be achieved. For example, the start of rice cooking control of the rice cooker included in the external equipment is assumed to be set to 17:00 in advance. In this case, the controller 172 transmits a command for instructing the room facility 200 to start rice cooking control of the rice cooker using the communication device 120 when the clock time measured by its own clock function part has reached 17:00 and causes a state in which a cooking start button of the rice cooker included in the operation interface is turned on to be displayed.

Also, when the room facility 200 includes a plurality of pieces of external equipment having the same function, the controller 172 may cause an operation interface for receiving the same operation details with respect to the plurality of pieces of external equipment to be shared and reproduce the operation interface within the vehicle. Thereby, when the occupant has operated an operation interface for issuing an instruction for turning off a lighting device within the vehicle, a lighting device of a living room and a lighting device of a bedroom can be turned off simultaneously.

Also, the controller 172 may limit the occupant capable of operating the operation interface among all occupants by determining the occupant capable of operating the operation interface in accordance with situations of the occupants within the vehicle. The situations of the occupants within the vehicle include a distribution of occupant positions within the vehicle, directions of lines of sight of the occupants, and the like. For example, image data acquired by a camera or the like provided within the vehicle is analyzed and information indicating the situation of the occupant within the vehicle is acquired by the controller 172. For example, the controller 172 may acquire a distance between the operation interface and the occupant on the basis of the position of the occupant within the vehicle and determine an occupant having a distance from the operation interface which is less than or equal to a threshold value or an occupant having a shorter distance from the operation interface than another occupant as an occupant capable of operating the operation interface. Also, the controller 172 may determine whether or not a reproduced image of the external equipment capable of being operated using the operation interface is viewed on the basis of a direction of a line of sight of the occupant and determine an occupant determined to view the reproduced image of the external equipment as an occupant capable of operating the operation interface.

Also, the controller 172 may create a room request regardless of an operation of the user U and transmit the room request to the management server 300. For example, the controller 172 creates a room request for issuing an instruction for reproducing room environments of a plurality of rooms (for example, a living room, a bedroom, and a kitchen). Then, the controller 172 continuously reproduces the room environments of the plurality of rooms on the basis of the information received from the management server 300. For example, the controller 172 changes the room environment to be reproduced so that the room environment is automatically changed at regular time intervals and the changed room environment is viewed.

In this case, the controller 172 provides an operation interface, which corresponds to the external equipment included in the room reproduced within the vehicle, within the vehicle and does not provide an operation interface, which corresponds to the external equipment included in the room that is not reproduced within the vehicle, within the vehicle. Also, the controller 172 may transmit a command for controlling the external equipment included in the room reproduced within the vehicle to the room facility 200 using the communication device 120 on the basis of an operation instruction received from the occupant. In this case, the controller 172 does not transmit a command to the external equipment even when the operation instruction received from the passenger is applicable to the external equipment included in the room that is not reproduced within the vehicle. Also, the operation instruction from the occupant is not limited to the operation interface implemented by the HMI 132 or the operation interface displayed within the vehicle by the projector. For example, the controller 172 may acquire the operation instruction from the occupant by sound. For example, when the occupant has said “Raise the volume of the television a little more”, the controller 172 may receive an operation instruction from the occupant on the basis of sound information acquired by the acquirer 173. That is, the controller 172 receives an operation on external equipment included in a room reproduced within the vehicle in preference to an operation on external equipment included in a room that is not reproduced within the vehicle. As described above, when a plurality of pieces of external equipment that can be operated are associated with one operation interface, the controller 172 may determine external equipment to be operated based on the operation interface on the basis of a predetermined priority order.

The identifier 175 identifies an individual in the interior of the vehicle 100 on the basis of information acquired by the acquirer 173. For example, the identifier 175 identifies an individual with reference to the storage 174. Information indicating the user's characteristics is registered in the storage 174 in advance. For example, information indicating characteristics of a face of the user, information indicating characteristics of voice of the user, information indicating characteristics of a fingerprint of the user, and the like are registered in the storage 174. The identifier 175 can identify an individual according to face authentication, voice authentication, fingerprint authentication, or the like with reference to the storage 174. Also, the identifier 175 may perform authentication through communication using a password input, QR code (registered trademark) authentication, or an IC card such as Felica, and may identify an individual on the basis of an authentication result.

The authenticator 176 determines whether or not the individual identified by the identifier 175 (or a vehicle equipped with the authenticator 176) has right to access the management server 300 with reference to information indicating a corresponding relationship with the management server 300 as will be described below. When the authenticator 176 determines that the individual has the right to access the management server 300, the controller 172 creates a room request.

The authenticator 176 determines whether or not the individual identified by the identifier 175 has the access right for controlling the external equipment with reference to information indicating a corresponding relationship with an external device to be described below and causes the controller 172 to generate a signal including the access right when the access right is present. That is, the authenticator 176 identifies external equipment capable of being used by the individual identified by the identifier 175 among pieces of external equipment registered in the “information indicating the corresponding relationship with the external device (to be described below)”. For example, the “information indicating the corresponding relationship with the external device” is information for identifying each of spaces where the external equipment is present (for example, a room ID), information for identifying each of individuals, information for identifying each of pieces of external equipment present in a space indicated by the room ID (for example, an external equipment ID), and information associated with the presence/absence of right to access each piece of external equipment, and is stored, for example, in a storage device mounted in the vehicle 100.

Also, the authenticator 176 may identify remotely controllable external equipment among pieces of external equipment present in a specified space on the basis of information received from the external equipment via the management server 300 and determine whether or not an individual identified by the identifier 175 can use the identified external equipment.

Also, the authenticator 176 may identify external equipment capable of being used by the individual identified by the identifier 175 (hereinafter referred to as available equipment) or external equipment incapable of being used by the individual identified by the identifier 175 (hereinafter referred to as unavailable equipment) among a plurality of pieces of external equipment present in the space (room) identified by the occupant via the acquirer 173 with reference to the above-described information indicating the corresponding relationship with the external device.

Also, the “information indicating the corresponding relationship with the external device” may be stored in the storage of the management server 300 and a process of the authenticator 176 as described above may be executed by a component included in the management server 300.

Also, the controller 172 selectively transmits the operation information acquired via the operation interface (implemented by the acquirer 173) to the management server 300 using the communication device 120. For example, when operation details indicated by the acquired operation information are operation details for external equipment (available equipment) for which the authenticator 176 determines that there is access right, the controller 172 transmits the operation information to the management server 300. On the other hand, when the operation details indicated by the acquired operation information are operation details for external equipment (unavailable equipment) for which the authenticator 176 determines that there is no access right, the controller 172 does not transmit the operation information to the management server 300.

Also, the controller 172 determines an operation interface to be connected to the external equipment on the basis of at least one of a type of external equipment present in the specified space (first requirement), access right indicating whether or not the use of the external equipment is permitted (second requirement), and a state of the external equipment (third requirement). For example, information indicating the state of the external equipment is state information to be described below.

For example, the controller 172 may display operation buttons corresponding to all pieces of external equipment present in the specified space on the touch panel included in the acquirer 173 on the basis of the first requirement. Furthermore, in consideration of the second requirement, the controller 172 may invalidate the operation buttons of the external equipment for which there is no access right among the operation buttons displayed on the touch panel or may not display the operation buttons on the touch panel.

Also, when new external equipment has been added as the room facility 200 in consideration of the third requirement, the controller 172 adds the new external equipment to the external equipment of the room facility 200 by communicating with the newly added equipment and acquiring necessary information and adds an operation button corresponding to the newly added external equipment to the touch panel. Also, likewise, when the external equipment of the room facility 200 has been removed from a space thereof, the controller 172 may exclude the removed external equipment from the external equipment of the room facility 200 and remove an operation button corresponding to the removed external equipment from the touch panel. Also, the controller 172 may cause operation buttons according to the control situation of the external equipment to be displayed on the touch panel when the control state of the external equipment has been changed in consideration of the third element. For example, when the external equipment is a recording device and the control state is a state in which recording is in progress, the controller 172 indicates that recording is in progress, displays an operation button for invalidating a recording operation, prevents a recording instruction from being accepted even when the operation button is operated, and prevents the same program from being redundantly recorded.

Also, the controller 172 may change the operation details received by the operation interface on the basis of the traveling state of the vehicle 100. For example, the controller 172 limits or expands some of the operation details received by the operation interface in accordance with the traveling state of the vehicle 100.

Specifically, some operation details are limited when the speed is greater than or equal to a certain level or the operation details are changed so that the size of characters and buttons become large to prevent the occupant from getting motion sickness due to a small operation interface at the time of a road over a mountain pass.

Also, when the external equipment 230 has been added to the specified space, the controller 172 adds an operation interface according to the function of the added external equipment 230. For example, when a vacuum cleaner has been added as the external equipment 230, the controller 172 adds an operation button for operating the vacuum cleaner to the touch panel included in the outputter 171.

### [Room Facility]

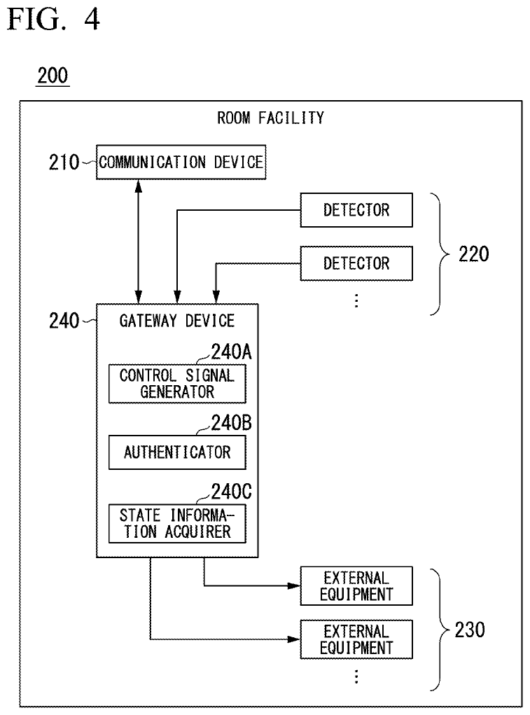

FIG. 4 is a functional configuration diagram of the room facility 200. The room facility 200 includes, for example, a communication device 210, one or more detectors 220, one or more pieces of external equipment 230, and a gateway device 240.

For example, the communication device 210 is a communication interface for connecting to the network NW or directly communicating with the vehicle 100. For example, the communication device 210 may include a network interface card (NIC), or may perform wireless communication on the basis of Wi-Fi, dedicated short range communications (DSRC), Bluetooth (registered trademark), or other communication standards. A plurality of communication devices 210 may be prepared according to a purpose.

The detector 220 is provided at a position where a room capable of being used by the user U, for example, a living room, a kitchen, and a child's room in a home of the user U, the interior of a workplace of the user U, or the like, is imaged. As the detector 220, for example, a 360° camera can be used. The detector 220 outputs captured image data (hereinafter referred to as image data) to the gateway device 240.

The external equipment 230 is external equipment installed in a room that can be used by the user U, and includes, for example, a television, a recording device, a refrigerator, a rice cooker, a microwave oven, an air conditioning device, a personal computer, a printer, a game machine, a treadmill, an electric sauna, and the like. Hereinafter, the external equipment 230 includes not only electrical equipment but also electronic equipment. The external equipment 230 may be connected to the gateway device 240 and controlled by the gateway device 240. Also, the external equipment 230 may generate state information indicating an operation state, a control state, and the like and output the state information to the gateway device 240. The state information may further include information indicating a model number, a color, a shape, and the like of the external equipment 230.

The gateway device 240 is connected to the communication device 210, the detector 220, and the external equipment 230 within the room and can cause the communication device 210, the detector 220, and the external equipment 230 to be operated as Internet of things (IoT) equipment. The gateway device 240 includes, for example, a processor such as a CPU, a control signal generator 240A (whose details will be described below), and an authenticator 240B.

The gateway device 240 controls the detector 220 and the external equipment 230 on the basis of the information received from the management server 300. For example, when information of an instruction for transmitting video data of the living room has been received, the gateway device 240 controls the detector 220 installed in the living room to acquire the video data and transmits the acquired video data to the management server 300 using the communication device 210. Also, when information of an instruction for recording of the television has been received, the gateway device 240 controls the external equipment 230 that is a recording device connected to the television to make a recording reservation for a specified program. Also, when a part of the state information has been input from the external equipment 230, the gateway device 240 may transmit the input information to the vehicle 100 using the communication device 210 or may transmit the input information to the vehicle 100 via the management server 300.

The authenticator 240B performs a process similar to that of the above-described authenticator 176. For example, it is determined whether or not there is access right for reproducing the room specified by an occupant (for example, an individual specified in the vehicle 100) with reference to the information indicating the corresponding relationship with the external equipment on the basis of information received from the management server 300 or the vehicle 100 using the communication device 210. When the access right is present, the authenticator 240B instructs the state information acquirer 240C to acquire the state information of the external equipment present in the specified room.

The authenticator 240B determines whether or not there is access right for each piece of external equipment present in the room specified by the occupant with reference to the information indicating the corresponding relationship with the external equipment on the basis of the received information. When the information received from the management server 300 or the vehicle 100 using the communication device 210 includes an operation instruction for external equipment for which there is access right, the authenticator 240B outputs information indicating that the authentication has succeeded to the control signal generator 240A. The control signal generator 240A generates a control signal according to the operation instruction included in the received information with respect to the external equipment successfully authenticated by the authenticator 240B and transmits the generated control signal to the management server 300 or the vehicle 100 using the communication device 210.

The state information acquirer 240C acquires information indicating the detection result detected by the detector 220 and operation details set in the external equipment 230 from the detector 220 or the external equipment 230. The state information acquirer 240C acquires state information of the external equipment on the basis of information input from the detector 220 or the external equipment 230 and transmits the state information to the management server 300 or the vehicle 100 using the communication device 210. The state information acquirer 240C may generate reproduction data on the basis of the acquired state information of the external equipment and may transmit the reproduction data to the management server 300 or the vehicle 100 using the communication device 210.

### [Management Server]

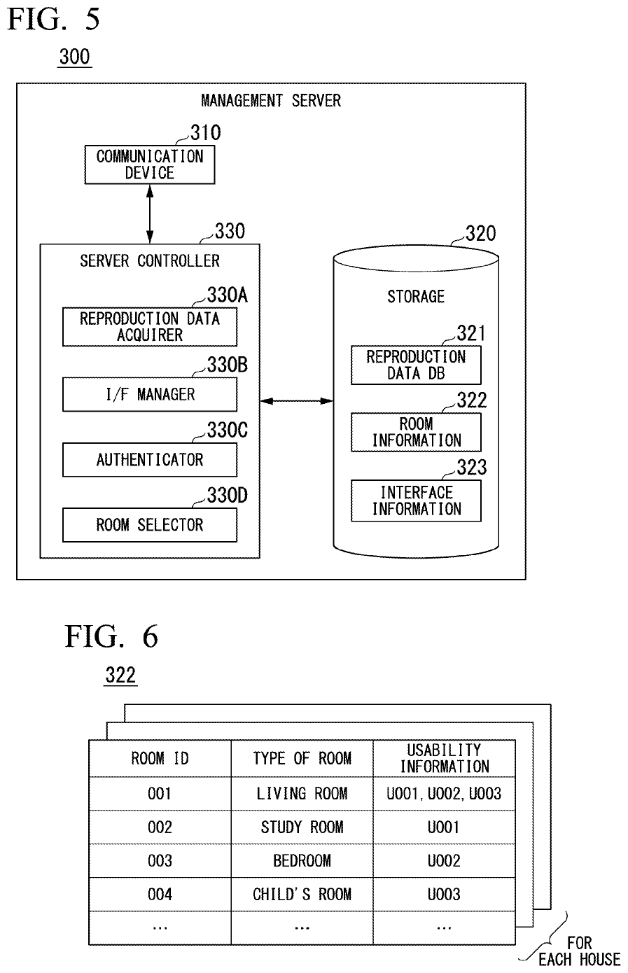

FIG. 5 is a functional configuration diagram of the management server 300. For example, the management server 300 manages communication between the vehicle 100 and the room facility 200. Also, some of the functions of the management server 300 to be described below may be implemented by the vehicle 100. The management server 300 includes, for example, a communication device 310, a storage 320, and a server controller 330. The communication device 310 is, for example, a NIC for connecting to the network NW. The communication device 310 communicates with the vehicle 100 or the room facility 200 via the network NW. The storage 320 is implemented by an HDD, a flash memory, a RAM, a ROM, or the like.

The server controller 330 includes, for example, a reproduction data acquirer 330A, an OF manager 330B, and an authenticator 330C. These functional parts are implemented, for example, by a processor such as a CPU executing a program (software) stored in the storage 320. Some or all of these functional parts may be implemented by hardware such as LSI, an ASIC, or an FPGA or may be implemented by cooperation between software and hardware.

The reproduction data acquirer 330A receives the room request transmitted from the vehicle 100 via the communication device 310 and the network NW, acquires the reproduction data according to the usage conditions included in the room request, and transmits the acquired reproduction data to the vehicle 100. The reproduction data acquirer 330A may acquire reproduction data from a reproduction data DB 321 saved in the storage 320 or may acquire reproduction data based on a captured video acquired in real time from the room facility 200.

The reproduction data DB 321 includes various reproduction data for reproducing the room. For example, an image obtained by processing an illustration image or a photograph for reproducing a room or the like is included. Also, the reproduction data is information for outputting a predetermined image to the interior of the vehicle using the outputter 171 such as a projector or a display as described above. The predetermined image may be an image projected into the vehicle or an image displayed on a display installed within the vehicle. That is, the reproduction data is information for outputting images of various items according to the room environment to the interior of the vehicle using the outputter 171, and includes information for outputting the image of the external equipment 230 to the interior of the vehicle using the outputter 171. The reproduction data DB 321 is, for example, a database that saves reproduction data prepared in advance in association with information indicating the type of room.

Also, the reproduction data acquirer 330A may generate reproduction data by compositing a part of the reproduction data DB 321 saved in the storage 320 with a captured video acquired in real time from the room facility 200. For example, the reproduction data acquirer 330A reads information for outputting an image of the external equipment from the reproduction data DB 321 and composites the read information with the captured video.

Also, the reproduction data DB 321 may include information for outputting an image according to the state of the external equipment. For example, when the state information has been received from the external equipment 230, the reproduction data acquirer 330A may read information indicating the state of the external equipment 230 from the reproduction data DB 321 and composite the read information with the captured video. The information representing the state of the external equipment 230 includes, for example, an image representing the state of the external equipment 230 by text, an image representing an image of the external equipment 230 operating in that state, and the like. The reproduction data acquirer 330A generates reproduction data that is displayed by superimposing a part or all of the information representing the state of the external equipment 230 on the image of the external equipment 230.

Also, the present invention is not limited to the above. The reproduction data acquirer 330A may generate reproduction data for causing information indicating the state of the external equipment 230 to be displayed in the vicinity of the image of the external equipment 230 after a remote operation from the vehicle 100 side is performed on the basis of operation information, on the basis of information indicating the state of the external equipment 230. The reproduction data is transmitted to the vehicle 100, so that the outputter 171 can output information indicating the state of the external equipment 230 after a remote operation is performed on the basis of the operation information to the interior of the vehicle.

In this manner, the environment provider 170 outputs an image based on the “reproduction data generated on the basis of the state information of the external equipment 230” to the interior of the vehicle, so that the environment provider 170 causes a situation of the image of the external equipment 230 output to the interior of the vehicle 100 to be synchronized with a situation of the external equipment 230 in a specified space.

Also, the reproduction data acquirer 330A may generate information for causing information indicating a function or a state of the external equipment 230 to be displayed on a part of the operation interface (such as a touch panel) and transmit information assigned to the reproduction data (or only information) or the like to the vehicle 100. For example, the controller 172 causes the touch panel to display an operation button according to a function or a control state of the external equipment 230 on the basis of the received information. Specifically, when the external equipment 230 is a recording device, the controller 172 causes the touch panel to display operation buttons corresponding to operation details that can be received by the recording device. Also, when the control state of the recording device is a state in which recording is in progress, the controller 172 indicates that recording is in progress, displays an operation button for invalidating a recording operation, prevents a recording instruction from being accepted even when the operation button is operated, and prevents the same program from being redundantly recorded. In this manner, by outputting an image based on the information received from the reproduction data acquirer 330A to the interior of the vehicle, the environment provider 170 can cause operation details received by the operation interface in the interior of the vehicle 100 to be synchronized with at least one of the function and the situation of the electronic equipment 230.

Also, the reproduction data acquirer 330A may generate information for outputting information indicating the function or the state of the external equipment 230 to the interior of the vehicle by sound and transmit the information to the vehicle 100.

Also, when new external equipment has been added to a space reproduced within the vehicle, the reproduction data acquirer 330A may read information corresponding to the added external equipment from the reproduction data DB 321 and composite the read information with the captured video.

Also, the reproduction data acquirer 330A may receive an authentication result of the authenticator 176 from the vehicle 100 (or acquire an authentication result of the authenticator 330C) and generate reproduction data according to the authentication result. For example, when information indicating external equipment capable of being used by an individual specified by the identifier 175 (hereinafter referred to as available equipment) or information indicating external equipment incapable of being used by an individual specified by the identifier 175 (hereinafter referred to as unavailable equipment) has been received from the vehicle 100, the reproduction data acquirer 330A generates reproduction data for causing the available equipment to appear and causing the unavailable equipment not to appear. For example, the reproduction data acquirer 330A may composite the reproduction data corresponding to the available equipment with the captured video and may composite a predetermined image for an unavailable state with the captured video at a position corresponding to the unavailable equipment. The image for the unavailable state includes, for example, an image filled with one color, an image in which text indicating the unavailable state is displayed, and the like. Also, a process of compositing the image for the unavailable state is not limited to the above, and, for example, a process of mosaicking a part corresponding to the unavailable equipment in the captured video or the like is included.

Also, a part or all of the reproduction data acquirer 330A described above may be implemented by the environment provider 170.

The I/F manager 330B establishes communication between the vehicle 100 and the external equipment 230 via the communication device 310 and the network NW. For example, the server controller 330 transmits operation information received from the vehicle 100 to the external equipment 230. Also, the server controller 330 transmits the state information received from the external equipment 230 to the vehicle 100.

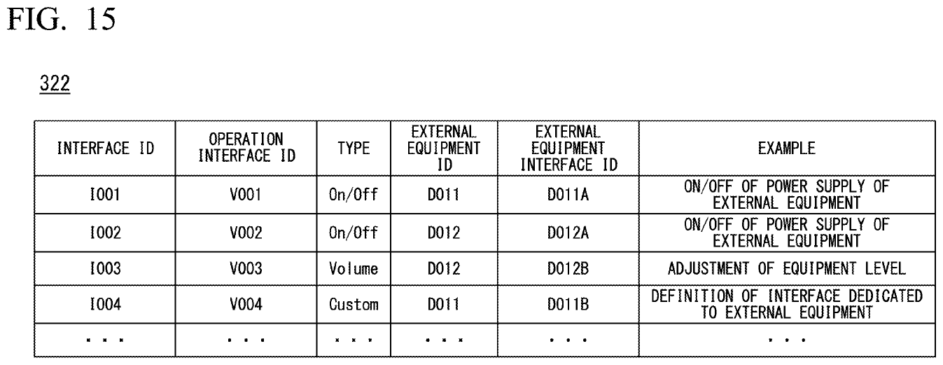

Also, the I/F manager 330B generates interface information 323 and stores the generated interface information 323 in the storage 320. FIG. 15 is a diagram showing an example of details of the interface information 323. As shown in FIG. 15, the interface information 323 is a table in which an interface ID, an operation interface ID, a type, an external equipment ID, and an external equipment interface ID are associated. The type is information indicating a type of operation interface. The external equipment ID is identification information for identifying external equipment. The external equipment interface ID is identification information for identifying an operation interface included in the external equipment. Also, the “example” shown in FIG. 15 is a specific example of the functional operation of the external equipment. The I/F manager 330B generates the interface information 323 on the basis of various types of information related to an operation interface prepared in advance. Various types of information about the operation interface prepared in advance include, for example, information indicating operation details that can be received by the operation interface indicated by the operation interface ID, information indicating operation details that can be received by the operation interface indicated by the external equipment interface ID, and the like. Also, the type “custom” indicates an operation interface set by the user. For example, when there is a functional operation of external equipment added as an operation interface by the user or when there is a functional operation of external equipment frequently used by the user, an operation interface set by the user is associated with a predetermined operation interface or an operation interface selected by the user.

As shown in FIG. 15, for example, an operation interface of the vehicle 100 side is associated with each of different operation interfaces included in the same external equipment 230. In this manner, a communication path between the operation interface of the vehicle 100 side and the operation interface of the external equipment 230 side can be established. Consequently, a pseudo room environment can be reproduced within the vehicle.

Also, the I/F manager 330B may manage communication with an external server (for example, the third party). For example, the I/F manager 330B determines whether or not communication with the external server is necessary on the basis of information received from the vehicle 100 (including a room request, an operation instruction for the external equipment 230, or the like). When communication with an external server is necessary, the I/F manager 330B may communicate with the external server and store interface information on the basis of acquired information after acquiring necessary information from the external server.

The authenticator 330C executes a process similar to that of the authenticator 176 described above. For example, it is determined whether or not the individual identified in the vehicle 100 has access right for controlling the external equipment 230 with reference to the information indicating the corresponding relationship with the external equipment on the basis of information received from the vehicle 100 using the communication device 210. When the access right is present, information indicating that the authentication has succeeded is output to the reproduction data acquirer 330A or the I/F manager 330B. The reproduction data acquirer 330A acquires reproduction data when the authentication of the authenticator 330C has succeeded. When the authentication of the authenticator 330C has succeeded, the I/F manager 330B transmits information of the vehicle 100 and the external equipment 230.

FIG. 6 is a diagram showing an example of the room information 322. The room information 322 is information about a room for which use permission is required and is information in which a type of room, usability information, and the like are associated with the room ID. For example, the room information 322 is stored in a table prepared for each house. The room ID is unique information for identifying each room among all available rooms. The usability information is information indicating the user U permitted to use each room, and includes, for example, a user ID. The user ID is unique information for identifying each user U.

The room selector 330D determines whether or not the room ID of the room specified by the user has been registered in room information 322 on the basis of the room request received from the vehicle 100. When the room ID has not been registered in the room information 322, the room selector 330D acquires reproduction data according to the room request from the reproduction data DB 321 and transmits the acquired reproduction data to the vehicle 100 transmitting the room request. On the other hand, when the room ID has been registered in the room information 322, the room selector 330D determines whether or not the user has been registered as a user whose use has been permitted. When the user has been registered as a user whose use has been permitted, the room selector 330D requests the room facility 200 in the specified room to transmit video data of the specified room.

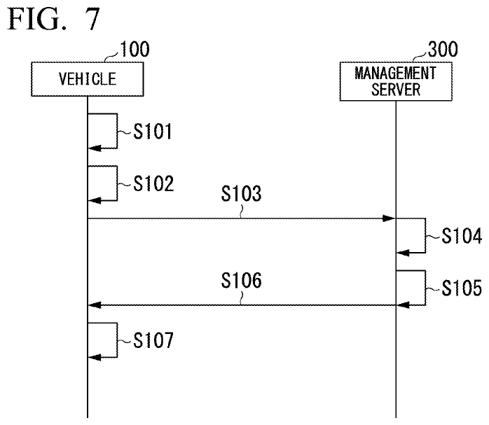

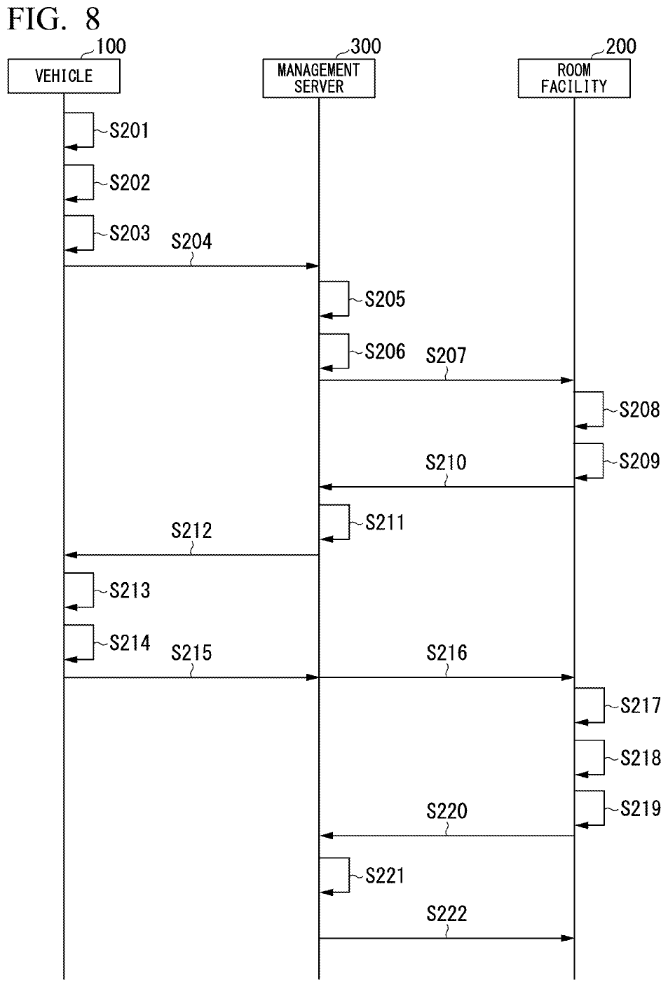

Next, an example of a process of the vehicle system 1 will be described with reference to FIG. 7. FIG. 7 is a sequence diagram showing an example of the process of the vehicle system 1. Here, an example in which reproduction of a room for which reproduction data is prepared in advance is requested from a user U1 will be described.

In the vehicle 100, for example, the controller 172 acquires information about the user with respect to the user U1 on the basis of information input from the acquirer 173 (step S101). The information about the user includes a name and an attribute of the user in the interior of the vehicle 100 (a family relationship, an official position, or the like). Also, when the individual of the user U1 has been specified by the identifier 175, the controller 172 may acquire information about the user from the identification result of the identifier 175.

Next, the controller 172 receives the type of room to be reproduced from the user U1 using the acquirer 173 (step S102). For example, the controller 172 receives one of rooms for which reproduction data is prepared as the type of room. Then, the controller 172 creates a room request including the acquired information about the user U1, the type of room, and the like and transmits the room request to the management server 300 using the communication device 120 (step S103).

In the management server 300, the room selector 330D determines whether or not the room ID of the specified room has been registered in the room information 322 with reference to the room information 322 of the storage 320 on the basis of the room request received from the vehicle 100 (step S104). In the present example, the room ID is not registered in the room information 322 because the specified room is one of the rooms for which reproduction data is prepared. Consequently, the reproduction data acquirer 330A reads the reproduction data of the specified room from the reproduction data DB 321 of the storage 320 on the basis of the room request received from the vehicle 100 (step S105) and transmits the read reproduction data to the vehicle 100 using the communication device 310 (step S106). In vehicle 100, the controller 172 outputs the reproduction data received from management server 300 to the outputter 171 using the communication device 120. The outputter 171 reproduces the room environment of the specified room in the interior of the vehicle 100 on the basis of the input reproduction data (step S107).

Next, another process example will be described with reference to FIG. 8. FIG. 8 is a sequence diagram showing an example of a process of the vehicle system 1. Here, an example in which reproduction of a current state of the specified room is requested from a user U2 will be described.

In vehicle 100, the controller 172 acquires information about a user with respect to the user U2 (step S201). For example, the controller 172 acquires information about the user from an identification result of the identifier 175.

Next, the controller 172 receives the type of room to be reproduced from the user U2 using the acquirer 173 (step S202). For example, the controller 172 receives one of the rooms for which a real-time video is reproduced as the type of room. The authenticator 176 determines whether or not there is access right for the management server 300 on the basis of the information about the user acquired in step S201 or the like (step S203). When there is access right for the management server 300, the controller 172 creates a room request including the information about the user acquired in step S201, the type of room received in step S202, and the like and transmits the room request to the management server 300 using the communication device 120 (step S204).

In the management server 300, the room selector 330D determines whether or not the room ID of the specified room has been registered in the room information 322 with reference to the room information 322 of the storage 320 on the basis of the room request received from the vehicle 100 (step S205). In the present example, because the specified room is a room where the room facility 200 is installed, the room ID is registered in the room information 322. Consequently, the room selector 330D determines whether or not the user ID included in the room request is included in the usability information corresponding to the room ID of the specified room in the room information 322 (step S206). When the user ID included in the room request is included in the usability information corresponding to the room ID of the specified room, the reproduction data acquirer 330A requests the room facility 200 installed in the specified room to transmit the video data of the specified room (step S207).

In the room facility 200, the authenticator 240B determines whether or not there is access right for reproducing the room specified by the occupant (for example, an individual identified in the vehicle 100) (step S208). When there is access right, the state information acquirer 240C acquires video data from the detector 220 installed in the specified room on the basis of the request received from the management server 300 and acquires information indicating the control state and the like from the external equipment 230 (step S209) and is transmitted to the management server 300 using the communication device 210 (step S210). In the management server 300, the I/F manager 330B generates interface information 323 on the basis of the information indicating the received control state, and stores the generated interface information 323 in the storage 320 (step S211). The server controller 330 transmits information indicating the received video data or control state, the generated interface information, and the like to the vehicle 100 using the communication device 310 (step S212). Here, the server controller 330 may transmit information obtained by compositing the illustration image or the like of the external equipment 230 with the video data as described above to the vehicle 100 or transmit the video data in which the external equipment 230 is shown to the vehicle 100.

In the vehicle 100, the environment provider 170 reproduces the room environment of the specified room within the vehicle 100 on the basis of the received video data and the like (step S213). That is, the environment provider 170 causes an image of the external equipment 230 and an image of a space where the external equipment 230 is present to be output to the interior of the vehicle using the outputter 171 on the basis of the received video data and the like. Also, the environment provider 170 causes the HMI 132 to display a predetermined operation interface, or causes the predetermined operation interface to be displayed within the vehicle using the outputter 171, on the basis of the received information indicating the control state and interface information.

Next, when the environment provider 170 has received an operation on a reproduction image or the like of the external equipment displayed within the vehicle from the user U2 (step S214), the environment provider 170 transmits operation information indicating details of the received operation to the management server 300 using the communication device 120 (step S215). Here, the environment provider 170 may be configured to determine whether or not the details of the received operation are details of an operation on the external equipment (the available equipment) for which the authenticator 176 determines that there is access right and to transmit operation information to the management server 300 only when it is determined that the details of the operation are details on the operation on the available equipment. When an image of external equipment (unavailable equipment) for which the authenticator 176 determines that there is no access right has not been output to the interior of the vehicle, the acquirer 173 which is an operation interface cannot receive details of an operation on the unavailable equipment. Thus, the environment provider 170 does not transmit operation information about the unavailable equipment to the management server 300.

The operation information indicating the operation details includes the room ID of the specified room, information indicating the external equipment, the operation details, and the like. The management server 300 transmits the received information indicating the operation details to the room facility 200 associated with the room ID included in the received information in the room information 322 (step S216). In the room facility 200, the authenticator 240B determines whether or not there is access right for each piece of external equipment present in the room specified by the occupant with reference to information indicating the corresponding relationship with the external equipment on the basis of the received information (step S217). When the received information includes an operation instruction for external equipment for which there is access right, the authenticator 240B outputs information indicating that the authentication has succeeded to the control signal generator 240A. The control signal generator 240A generates a control signal according to the operation instruction included in the received information for the external equipment successfully authenticated by the authenticator 240B and outputs the control signal to the corresponding external equipment 230 (step S218). In this manner, in the room facility 200, the gateway device 240 can control the external equipment 230 on the basis of the received information indicating the operation details. As described above, the environment provider 170 can remotely operate the external equipment 230 by selectively connecting the operation interface to the external equipment 230.

Next, the control signal generator 240A determines whether or not parallel processing of an associated device is necessary on the basis of the control signal generated in step S218. The parallel processing of the associated device includes a process in the associated device necessary for controlling the external equipment 230, a process in the associated device operating in cooperation with the control of the external equipment 230, and a process in a higher-order (master) associated device that controls the external equipment 230, and the like. For example, when the associated device of a certain room depends on external equipment 230 of another room, the control signal generator 240A also controls the associated device of the master side in parallel when the external equipment 230 is controlled. When the parallel processing of the associated device is necessary, the control signal generator 240A generates a control signal for the associated device and controls the associated device (step S219).

Also, when the associated device is not included in the room facility 200, the gateway device 240 transmits a control signal for the associated device to the management server 300 using the communication device 210 (step S220). The management server 300 transmits the control signal for the associated device to the associated device using the communication device 310 (step S221). When it is possible to control the associated device, the management server 300 may transmit the fact that it is possible to control the associated device to the room facility 200 (step S222). In the room facility 200, the control signal generator 240A may further control the external equipment 230 on the basis of information received from the management server 300.

The server controller 330 of the management server 300 may receive state information indicating the state of the external equipment 230 from the room facility 200. In this case, the server controller 330 transmits the received state information to the corresponding vehicle 100. Also, as described above, the server controller 330 may generate reproduction data on the basis of the received state information and transmit the reproduction data to the corresponding vehicle 100.

When the interface information 323 has been generated in step S211, the management server 300 establishes communication between the external equipment 230 and the environment provider 170 with which operation interfaces are mutually associated in the interface information 323. When the communication between the external equipment 230 and the environment provider 170 is established, the state of the external equipment reproduced within the vehicle 100 is synchronized with the state of the external equipment 230 in the specified room. For example, the communication is established, so that the management server 300 can continuously transmit the video data received from the room facility 200 to the vehicle 100 side. Thereby, the situation of the specified room is reproduced within the vehicle with a time difference substantially in real time.

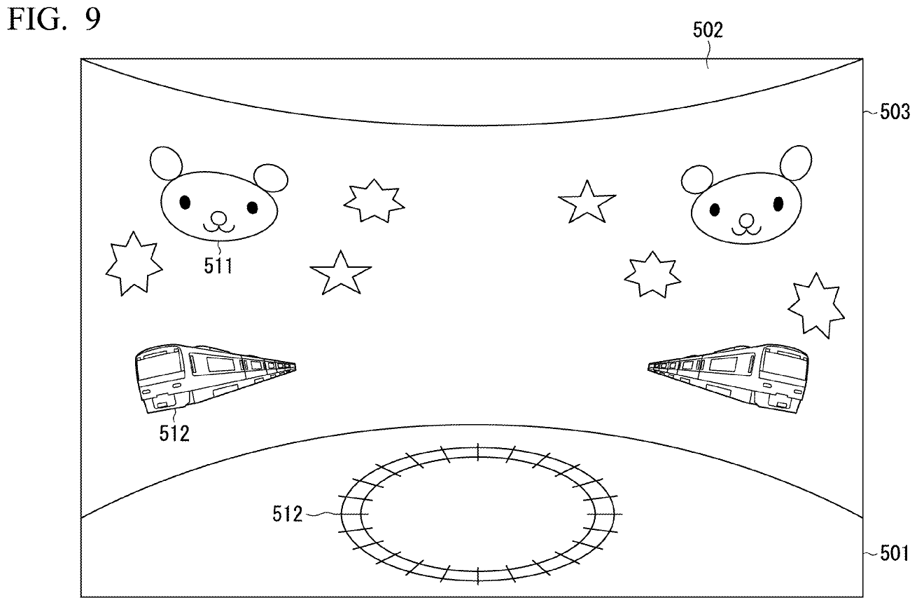

Next, an example of a room implemented by the vehicle system 1 will be described with reference to FIGS. 9 to 12. FIGS. 9 to 12 are diagrams showing parts of the interior of the vehicle 100. FIGS. 9 to 12 show states of the vehicle 100 viewed from the front or the rear using a perspective method. Inside the vehicle 100, a floor surface 501, a ceiling 502, and a side surface 503 are included. Illustrations of tables and chairs capable of being installed within the vehicle 100 are omitted.

FIG. 9 is a diagram showing an example of a child's room reproduced within the vehicle 100. As shown in FIG. 9, when occupants include the child, the environment provider 170 transmits a room request for the child's room to the management server 300 using the communication device 120 and receives reproduction data of the child's room from the management server 300. The environment provider 170 reproduces images of a character 511 and an item 512 with which the child is happy on at least some of the floor surface 501, the ceiling 502, and the side surface 503 of the vehicle 100 on the basis of the received reproduction data. Thereby, the user can enjoy the time within the vehicle. Also, the atmosphere and items of the room environment may be changed in accordance with a sex, an age, preference, and the like of the child which gets into the vehicle. Also, the environment provider 170 moves or stores the seats of the vehicle 100 to secure a space for the child to play and colors and displays a seat surface (skin) or a surface of the interior of the vehicle on the basis of color information included in the reproduction data so that the atmosphere of the child's room is produced.

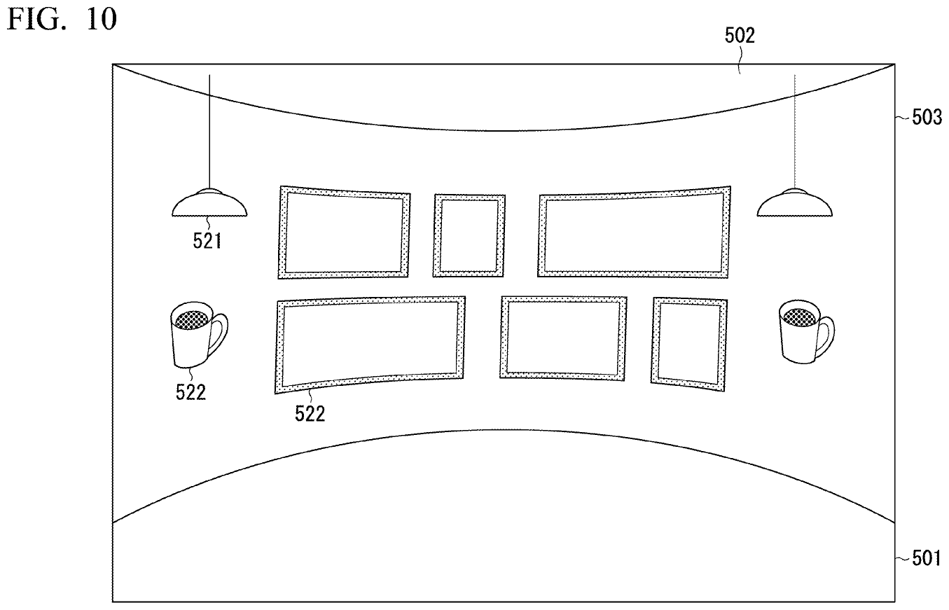

FIG. 10 is a diagram showing an example of a cafe-like room reproduced within the vehicle 100. When occupants include a user who returns home from work, the environment provider 170 transmits a room request for requesting the cafe-like room as shown in FIG. 10 to the management server 300 using the communication device 120 and receives the reproduction data of the cafe-like room from the management server 300. The environment provider 170 reproduces images of a cafe-like interior design 521, an interior facility 522, and the like on at least some of the floor surface 501, the ceiling 502, and the side surface 503 of the vehicle 100 on the basis of the received reproduction data. The cafe-like interior design 521 includes, for example, illustrations, photos, and the like of a frame with a nice photo, a blackboard on which a menu is written, and a coffee cup. The cafe-like interior facility 522 includes stylish lighting, an espresso machine, and the like. Thus, the user can enjoy the tea time as if he/she were in a cafe using the movement time to a destination. Also, the environment provider 170 may change the atmosphere and items of the room environment in accordance with a drink, a time period, a season, and the like. Also, the environment provider 170 moves or stores the seats of the vehicle 100 to secure a space or arrange each seat at a position according to the received reproduction data and reproduces the seat and the atmosphere of the cafe by coloring and displaying a seat surface (skin) or a surface of the interior of the vehicle on the basis of color information included in the reproduction data.

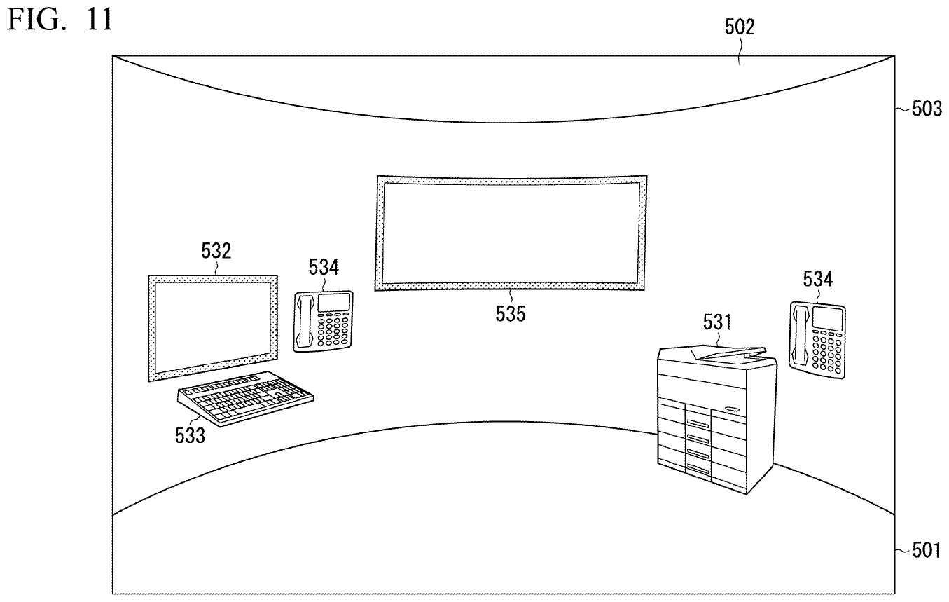

FIG. 11 is a diagram showing an example of a work room reproduced within the vehicle 100. As shown in FIG. 11, when occupants include a user who goes to work, the environment provider 170 transmits a room request for requesting a work room to the management server 300 using the communication device 120 and receives reproduction data of the work room from the management server 300. The environment provider 170 reproduces an image of an interior design like equipment installed in an office or an office on at least some of the floor surface 501, the ceiling 502, and the side surface 503 of the vehicle 100 on the basis of the received reproduction data. Examples of the equipment installed in the office include a printer 531, a personal computer screen 532, a keyboard 533, a telephone 534, a whiteboard 535, and the like. These are examples of the external equipment. The interior design like the office can be selected by the user from a plurality of settings according to a type of job and a simple design may be reproduced for desk work, various photos may be displayed in slides so that creative ideas are imagined, or news, received mail details, and the like may be displayed in slides. Thereby, the user can start a part of work while switching a mood to a work mode using the travel time until a destination is reached. Also, the environment provider 170 may display an enlarged view of a touched target when the user touches a photograph, news, email details, or the like reproduced within the vehicle 100 or may transmit information related to a terminal device possessed by the user.

Also, in FIGS. 9 to 11, the environment provider 170 moves or stores the seats of the vehicle 100 to secure the space or arrange each seat at a position according to the received reproduction data and colors and displays a seat surface (skin) or a surface of the interior of the vehicle on the basis of color information included in the reproduction data. For example, in the example of FIG. 11, the seat of the vehicle 100 is moved or stored, or a shape is deformed to reproduce an office chair, and a seat surface (skin) or a surface of the interior of the vehicle is colored and displayed on the basis of color information included in reproduction data for reproducing an office so that the atmosphere of the office is reproduced. By performing such control, facilities provided in the vehicle 100 can be utilized effectively. Also, for example, the occupant can feel a room desired to be reproduced by absorbing a difference between details or a shape of the room to be reproduced and details or a shape of the interior of the vehicle according to the above-described control.

In addition, the environment provider 170 reproduces a living room, a child's room, a wooden room, a bedroom, and the like and therefore the user can enjoy the travel time with a relaxed feeling. Also, the environment provider 170 reproduces a room environment similar to that at home or in a workplace and therefore the user is likely to feel more relaxed.

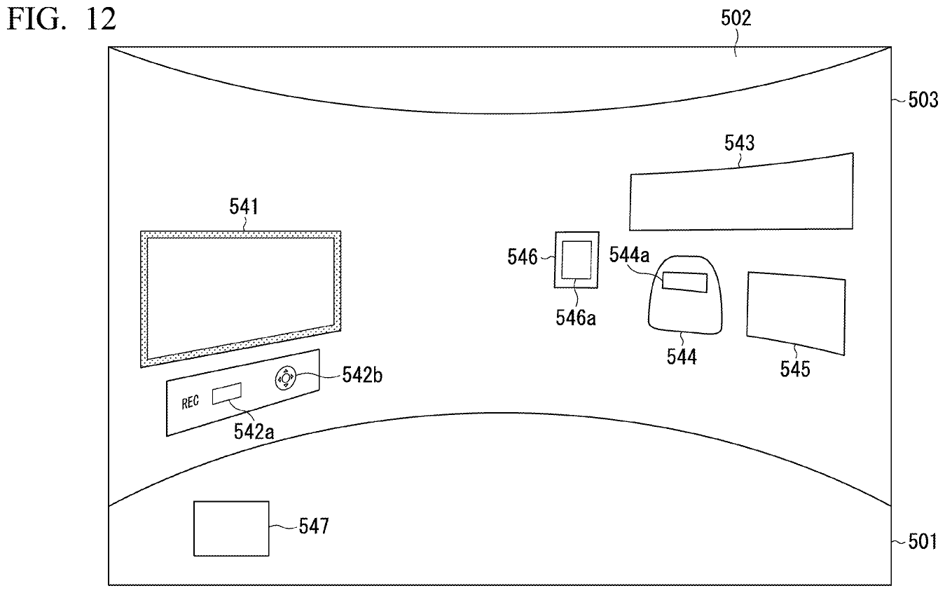

FIG. 12 is a diagram showing an example of a living room of a user's home reproduced within the vehicle 100. As shown in FIG. 12, the environment provider 170 transmits a room request for requesting the living room of the user's home to the management server 300 using the communication device 120. The management server 300 acquires video data of the living room from the room facility 200 of the specified user and transmits the acquired video data to the environment provider 170. On the basis of the received video data, the environment provider 170 reproduces images of external equipment such as a television 541, a recording device 542, an air conditioner 543, a rice cooker 544, a microwave oven 545, and a security device 546 at the user's home on a side surface 503 of the vehicle 100. The recording device 542 includes images of a recording button 542a and a selection button 542b. The rice cooker 544 includes an image of an operation panel 544a including a start button, operation buttons, and the like. The security device 546 includes an image of the operation panel 546a. When it is detected that the reproduced operation buttons or the like of the external equipment have been operated, the environment provider 170 transmits information indicating the detected operation details to the management server 300 using the communication device 120. The management server 300 transfers the received information to the specified room facility 200. The external equipment 230 of the specified room facility 200 operates on the basis of the information transmitted from the management server 300.

The details will be specifically described below. The management server 300 identifies a control target (goods in the user's home or the like) on the basis of information indicating the operation details received from the environment provider 170 and authentication information of the authenticator 176 and transmits a signal generated by combining a control signal for the control target with the authentication information to the room facility 200. When the authenticator 240B of the gateway device 240 of the room facility 200 checks access right for the external equipment 230 of the control target on the basis of a signal received from the management server 300 and controls the above-described external equipment 230 when it is determined that there is access right. For example, the authenticator 240B determines whether or not there is access right for controlling the above-described external equipment 230 on the basis of authentication information included in the received signal. When the authenticator 240B determines that there is access right for controlling the external equipment 230, the control signal generator 240A converts the received signal into a signal for controlling the external equipment 230, and transmits the converted signal to the external equipment 230 to be controlled. Then, the external equipment 230 is controlled.

Thereby, the user can operate the recording device in the living room at home while moving on the vehicle 100 by operating the recording button 542a. Also, the user can turn on a power supply of the rice cooker at home one hour before going home by operating the operation panel 544a and turn on a power supply of a home security device left behind when he/she was at home by operating the operation panel 546a.

Then, the gateway device 240 transmits state information input from the external equipment 230 to the vehicle 100 via the communication device 210. For example, it is assumed that the vehicle 100 has received state information indicating that the recording device is performing recording. In this case, the environment provider 170 of the vehicle 100 causes an image (including text, an illustration, and the like) indicating that recording is in progress to be superimposed and displayed on the image of the recording device output to the interior of the vehicle 100.

Also, the recording button 542a, the selection button 542b, the operation panel 544a, and the operation panel 546a may be implemented by a terminal device 547 installed within the vehicle 100. For example, the terminal device 547 causes a button corresponding to an operation button or the like of equipment reproduced within the vehicle 100 to be displayed on the basis of the information received from the environment provider 170 and transmits the received operation details to the environment provider 170. Thereby, it is only necessary for the user only to operate the terminal device 547 at hand and the operability is improved.

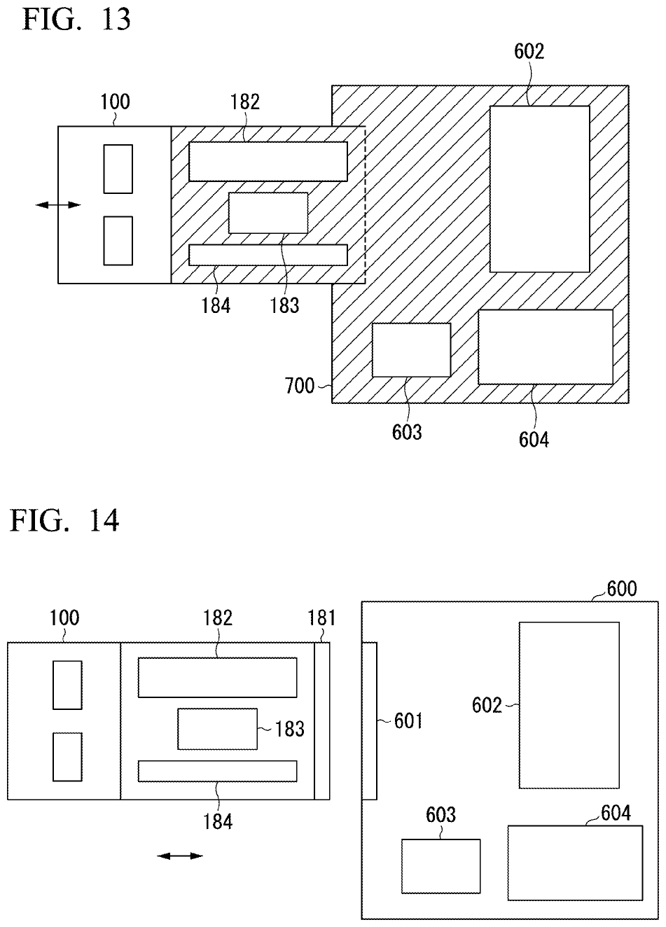

Also, the vehicle 100 may be used as a part of an actual room like an actual room of a home or the like. FIG. 13 is a view of a state in which a combination room region 700 appears as a result of combining the vehicle 100 and a room 600 viewed from above. FIG. 14 is a view of a state in which the vehicle 100 and the room 600 are separated viewed from above.

In the room 600, for example, a shutter device 601, a bed 602, a refrigerator 603, a bathroom 604, and the like are installed. The shutter device 601 is one of pieces of external equipment 230 installed in the room 600. The vehicle 100 includes, for example, a back door 181 and a sofa 182, a table 183, a television 184 and the like are included therein. On the upper surface of the table 183, a touch panel of the acquirer 173 may be mounted or a personal computer, a tablet terminal, or the like that communicates with the acquirer 173 may be mounted.

In the vehicle 100, when the approach to the room 600 where position information is registered in advance is detected on the basis of a position of its own device measured by the GNSS receiver 134, the environment provider 170 transmits a signal for an instruction for opening the shutter device 601 (hereinafter referred to as a shutter open signal) to the room facility 200 using the communication device 120. The gateway device 240 transmits a control signal to the shutter device 601 and opens the shutter. When the shutter has been completely opened, the gateway device 240 transmits information indicating that the shutter has been opened to the vehicle 100 using the communication device 210. When the vehicle 100 has received information indicating that the shutter has been opened, the automated driving control unit 150 causes the vehicle 100 to be moved to a predetermined parking position and causes the vehicle to be stopped. When the vehicle 100 has been parked at a predetermined parking position, a combination room region 700 including the vehicle 100 and the room 600 appears as shown in FIG. 13. Thereby, the user can also use the vehicle 100 as a part of the room 600. Also, when the user goes out on the vehicle 100, the user can move in a state in which a part of the combination room region 700 is transferred.

Also, the present invention is not limited thereto and the shutter opening signal may be transmitted to the shutter device 601 by the user operating the acquirer 173 serving as a remote controller or a touch panel.

Also, the environment provider 170 may cause settings in the room 600 to be reflected within the vehicle 100 and the gateway device 240 may cause settings in the vehicle 100 to be reflected in the room 600. For example, the environment provider 170 may set the same details as settings of a temperature, an operation mode, and the like of the air conditioning device installed in the room 600 in the air conditioning device of the vehicle 100, output a program or video content that is being reproduced by a television installed in the room 600 from the outputter 171 of the vehicle 100, or output music content that is being reproduced by audio equipment installed in the room 600 from the outputter 171. Also, in contrast, the gateway device 240 may control the air conditioning device, the television, the audio equipment, or the like on the basis of an air conditioning temperature set in the vehicle 100, video content or the music content that is being reproduced, and the like. Thereby, a seamless environment can be provided in the combination room region 700.

Also, the environment provider 170 may also control an air conditioning facility installed in the room 600 from the time which is a predetermined period of time earlier than a scheduled time when the vehicle 100 arrives at the room 600 so that the set temperature of the room 600 is the same as the temperature within the vehicle 100 when the vehicle 100 has arrived at the room 600. Also, the environment provider 170 may cause content to be reproduced in the vehicle 100 to be synchronized with content to be reproduced in the room 600 so that video content and music content are continuous in the combination room region 700.

According to the above-described embodiment, the automated driving control unit 150 configured to execute the automated driving of the vehicle 100 and the environment provider 170 configured to provide a pseudo room environment when the vehicle 100 is traveling or stopped in in the interior of the vehicle 100 are provided, so that it is possible to provide a room environment according to the user's needs.

Also, because the user can remotely control the external equipment 230 installed in an available room while getting into the vehicle 100 and the user can do what to do at home or in a workplace while getting into the vehicle 100, time can be utilized effectively.

Although modes for carrying out the present invention have been described above using embodiments, the present invention is not limited to the embodiments, and various modifications and substitutions can also be made without departing from the scope and spirit of the present invention.

For example, the environment provider 170 may adjust a position of an image projected by the projector and a position of an image displayed on the display in accordance with movement of the user or vibrations of the vehicle 100.

For example, the environment provider 170 includes a sensor configured to detect vibrations of the vehicle 100 and acquires information indicating a direction and a magnitude of vibrations of the vehicle 100 (hereinafter referred to as vibration information) on the basis of a detection result of the sensor. The environment provider 170 may adjust a position of an image projected by the projector or a position of an image displayed on the display on the basis of the acquired vibration information. For example, the environment provider 170 may cause the position of the image of the reproduction data to be moved by the magnitude of the vibrations of the vehicle 100 in a direction opposite to a vibration direction of the vehicle 100. Thereby, in the reproduced image, it is possible to cancel the vibrations of the vehicle and contribute to prevention of car sickness.

Also, the environment provider 170 may detect the movement of the user on the basis of the detection result from the camera or the sensor provided in the acquirer 173. When the number of times that an operation of erroneously pressing an operation button of external equipment reproduced within the vehicle 100 is detected is greater than or equal to a threshold value, the environment provider 170 may reproduce the operation button of the external equipment at a position obtained by subtracting an amount of vibration on the basis of the vibration information and the user's movement. Thereby, the operation button can be displayed in a place where the user erroneously presses the operation button.

Also, the environment provider 170 may adjust the position of the image as described above with respect to a part that is reproduced within the vehicle 100. For example, the environment provider 170 may detect the user's field of view using line-of-sight recognition technology on the basis of detection results from the camera and the sensor provided in the acquirer 173 and may perform the above-described image position adjustment with respect to the display within a fixed range including surroundings around the detected field of view. Also, the environment provider 170 may perform the above-described image position adjustment in the video of the external equipment 230 reproduced in the vehicle 100.

Also, the pseudo room environment to be reproduced is not limited to the interior of an actual room. For example, the pseudo room environment may be a room environment where the outdoor scenery of a sea or a mountain spreading out before the user's eyes is expressed on the wall, a room environment where world views of stories such as comics or novels are expressed in a room design or a room interior, or the like. Also, the pseudo room environment to be reproduced may include humans and animals such as children and pets in a living room at home, and a cram school teacher in a cram school classroom.

Also, the environment provider 170 may cause a change in a part of the specified actual room to be reflected within the vehicle 100 and the gateway device 240 may cause a change in the room reproduced within the vehicle 100 to be reflected in the specified actual room. For example, when a whiteboard placed in an actual room is also reproduced within the vehicle 100, information written on the whiteboard in the actual room is read by an electronic method and displayed on the whiteboard of the vehicle 100. In contrast, the information written on the whiteboard of the vehicle 100 may be read by the electronic method and displayed on the whiteboard in the actual room. Also, the environment provider 170 may mirror and display images displayed on the displays of both pieces of external equipment 230 in videos of the external equipment 230 installed in the actual room and the external equipment 230 reproduced in the vehicle 100.

Also, the environment provider 170 and the server controller 330 may create reproduction data in which the layout of the specified actual room is changed in accordance with the interior of the vehicle 100 or may create reproduction data in which some of two or more actual rooms are composited. Thereby, even if a shape and an area of the actual room are different from a shape and an area of the vehicle 100, a similar atmosphere and necessary external equipment can be reproduced.

Also, the environment provider 170 may select a type of room in accordance with the user's action within the vehicle 100 and create a room request on the basis of the selected type of room. For example, when the outputter 171 of the vehicle 100 reproduces a movie and the user views the movie, the environment provider 170 may select a movie theater in the type of room in accordance with content output by the outputter 171. Also, when the outputter 171 of the vehicle 100 reproduces music and the user listens to music, the environment provider 170 selects an opera house as the type of room in accordance with details of content output by the outputter 171.

Also, the environment provider 170 may select the type of room in accordance with a user who is within the vehicle 100 or a combination of users. For example, the environment provider 170 may specify a type of room that has been selected at the highest frequency on the basis of a previous designation history of users. If the users are a combination of a child and a parent, the child is given priority and a child's room may be specified. If a combination of users is members of a company, a meeting room may be specified.

Also, the environment provider 170 may specify a room according to a destination of the vehicle 100. For example, when the destination is a sea, a room having a room design of a view of the sea may be specified. When the destination is a theme park, a room having a room design of theme park characters may be specified.

The operation interface may be implemented in a type of application programming interface (API) or the like.

### REFERENCE SIGNS LIST

1 Vehicle system
100 Vehicle
110 External environment monitoring unit
120 Communication device
130 Navigation device
140 Recommended lane determination device
150 Automated driving control unit
160 Driving force output device
162 Brake device
164 Steering device
170 Environment provider
171 Outputter
172 Controller
173 Acquirer
174 Storage
175 Identifier
200 Room facility
210 Communication device
220 Detector
230 External equipment
240 Gateway device
300 Management server
310 Communication device
320 Storage
321 Reproduction data DB
322 Room information
330 Server controller

1. A vehicle system comprising:
an automated driving controller configured to execute automated driving of a vehicle; and
an environment provider configured to provide an interior of the vehicle with state information indicating a state of external equipment operable using an operation interface in the interior of the vehicle when the vehicle travels or stops, the external equipment being external equipment outside the vehicle.

2. The vehicle system according to claim 1, wherein the environment provider provides the interior of the vehicle with at least one of information indicating a control state of the external equipment and an external state of the external equipment detected by a detector outside the external equipment.

3. The vehicle system according to claim 1, wherein the environment provider provides the interior of the vehicle with the operation interface with respect to a remotely operable functional operation among all functional operations provided in the external equipment.

4. The vehicle system according to claim 3, wherein the environment provider causes operation details received by the operation interface to be synchronized with a control state of the external equipment on the basis of the state information.

5. The vehicle system according to claim 1, further comprising an identifier configured to identify an individual within the vehicle,
wherein the environment provider identifies the external equipment capable of being used by the individual identified by the identifier and is connected to the identified external equipment.

6. The vehicle system according to claim 1, wherein the environment provider includes a projector and causes the state information of the external equipment to be displayed within the vehicle.

7. The vehicle system according to claim 1, further comprising a communicator configured to communicate with the external equipment,
wherein the environment provider recognizes an operation on the operation interface performed by a person within the vehicle and controls the communicator so that the communicator transmits a control signal corresponding to the recognized operation to the external equipment.

8. The vehicle system according to claim 1, wherein the environment provider changes operation details, which are received by the operation interface, on the basis of a traveling state of the vehicle.

9. The vehicle system according to claim 1, wherein, when the external equipment has been added, the environment provider adds the operation interface according to a function of the added external equipment.

10. The vehicle system according to claim 1, wherein the environment provider determines the operation interface connected to the external equipment on the basis of at least one of a type of the external equipment, access right indicating whether or not use of the external equipment has been permitted, and a state of the external equipment.

11. A vehicle system comprising:
an automated driving controller configured to execute automated driving of a vehicle;
an environment provider configured to provide an interior of the vehicle with state information indicating a state of external equipment controllable using an operation interface in the interior of the vehicle when the vehicle travels or stops, the external equipment being external equipment outside the vehicle; and
a management device configured to manage communication between the automated driving controller and the environment provider.
